(19) United States
(12) Patent Application Publication
(10) Pub. No.: US 2017/0118588 A1
(43) Pub. Date: Apr. 27, 2017

(54) METHOD AND DEVICE FOR DETERMINING LOCATION OF VEHICLE ELECTRONIC KEY

(71) Applicant: LEAUTO INTELLIGENT TECHNOLOGY (BEIJING) CO.LTD, Beijing (CN)

(72) Inventors: Dan LI, Beijing (CN); Yong XU, Beijing (CN); Kunsheng CHEN, Beijing (CN); Wenrui LI, Beijing (CN); Peng LIU, Beijing (CN); Yu ZOU, Beijing (CN); Wei LIN, Beijing (CN)

(21) Appl. No.: 14/972,043

(22) Filed: Dec. 16, 2015

(30) Foreign Application Priority Data
Oct. 21, 2015 (CN) 201510686664.2

(51) Int. Cl. H04W 4/02; G08B 21/24; H04L 29/06; H04W 8/00

(52) U.S. Cl. CPC H04W 4/02; H04W 8/005; G08B 21/24; H04L 63/08

(57) ABSTRACT

The present disclosure provides a method and a device for determining a location of a vehicle electronic key, which includes: an intelligent terminal device transmits a pending information to a vehicle electronic key located within a designated area range, the pending information comprises an authentication request information and an operation indicating information of an user identity of the intelligent terminal device, and the operation indicating information is used for indicating that an setting operation is performed after the vehicle electronic key authenticates the user identity of the intelligent terminal device; the intelligent terminal device receives a response result information generated by the vehicle electronic key performing the setting operation, wherein the intelligent terminal device or the user using the intelligent terminal device determines the vehicle electronic key is in the location within the designated area range according to the response result information.

### CROSS REFERENCE TO RELATED APPLICATION

This application claims priority under 35 U.S.C. §119(a) to Patent Application No(s). 201510686664.2, filed in China on Oct. 21, 2015, the entire contents of which are hereby incorporated by reference.

### FIELD OF TECHNOLOGY

The present disclosure is related to communication technology field, and more particular to a method and a device for determining a location of a vehicle electronic key.

### BACKGROUND

With the rapid development of the science and technology and the progress of the times, a variety of vehicles are launched into the market. No matter what type of the vehicle, the safety is the most important. In order to ensure the safety of the whole vehicle, each vehicle is equipped with a vehicle electronic key. The vehicle electronic key is an inductive key, which the interior has a sensing chip. The user uses the sensing chip in the interior of the vehicle electronic key to interact with the sensing apparatus in the interior of the vehicle, so as to achieve a variety of operations for the vehicle, such as opening or closing the door, turning on or turning off the engine.

The vehicle electronic key provides the great convenience for the people to perform a variety of operations for the vehicle. However, since the vehicle electronic key is usually a small object, it may easily be lost or left out. After once the key is lost or left behind, the user often takes a long time to search the vehicle electronic key, thereby causing the great inconvenience for the user to travel.

In the prior art, for the convenience of the user to search the vehicle electronic key, one approach is that a searcher is hanged on the vehicle electronic key, and the searcher uniquely corresponds to a transmitter. The transmitter transmits an electronic signal The electronic signal has a specific frequency range, and the searcher corresponding to the transmitter uniquely receives the electronic signal of the frequency range. After the searcher receives the electronic signal transmitted by the transmitter, the searcher may generate a voice. Thus, when the user does not find the vehicle electronic key, the transmitter starts to transmit an electronic signal. After the searcher hanged on the vehicle electronic key receives the electronic signal, the searcher may generate a voice, and thus the user may determine the location of the vehicle electronic key according to the voice, so as to find the vehicle electronic key.

However, the existing method for searching the vehicle by using the searcher at least has the following problem.

An unique corresponding relationship between the searcher and the transmitter is determined by the electronic signal of the specific frequency range. However, the electronic signal with the specific frequency is easily obtained by the illegal user. Once the illegal user obtains the electronic signal with the specific frequency range, the illegal user may simulate to obtain the same transmitter and use the transmitter obtained by the simulation to obtain the vehicle electronic key of the user, thereby decreasing the safety of the vehicle electronic key of the user.

### SUMMARY

The present disclosure provides a method and a device for determining a location of a vehicle electronic key, thereby solving the problem that the safety of the method for searching the vehicle electronic key by using a searcher in the prior art is low.

An embodiment of the present disclosure provides a method for determining a location of a vehicle electronic key, which includes:

transmitting a pending information to a vehicle electronic key located within a designated area range by an intelligent terminal device, wherein the designated area range is an area range which the vehicle electronic key exists, the pending information includes an authentication request information and an operation indicating information of an user identity of the intelligent terminal device, and the operation indicating information is used for indicating that an setting operation is performed after the vehicle electronic key authenticates the user identity of the intelligent terminal device; and

receiving a response result information generated by the vehicle electronic key performing the setting operation through the intelligent terminal device, wherein the intelligent terminal device or the user using the intelligent terminal device determines the location within the designated area range for the vehicle electronic key according to the response result information.

An embodiment of the present disclosure further provides a method for determining a location of a vehicle electronic key, which includes:

receiving a pending information transmitted by an intelligent terminal device through a vehicle electronic key located within a designated area range, wherein the designated area range is an area range which the vehicle electronic key exists, the pending information includes an authentication request information and an operation indicating information of an user identity of the intelligent terminal device, and the operation indicating information is used for indicating that an setting operation is performed after the vehicle electronic key authenticates the user identity of the intelligent terminal device;

performing an authentication process for the authentication request information of the user identity of the intelligent terminal device through the vehicle electronic key, and performing the setting operation according to the operation indicating information after the authentication; and

transmitting the response result information generated by the vehicle electronic key performing the setting operation to the intelligent terminal device through the vehicle electronic key, such that the intelligent terminal device or the user using the intelligent terminal device determines the location within the designated area range for the vehicle electronic key according to the response result information generated by the vehicle electronic key performing the setting operation.

An embodiment of the present disclosure further provides apparatus used for determining a location of a vehicle electronic key, which includes:

a processor; and

a memory containing a program, when executed by the processor, the processor executes the following steps:

transmitting a pending information to a vehicle electronic key located within a designated area range by an intelligent terminal device, wherein the designated area range is an area range in which the vehicle electronic key exists, the pending information comprises an authentication request information and an operation indicating information of an user identity of the intelligent terminal device, and the operation indicating information is used for indicating that an setting operation is performed after the vehicle electronic key authenticates the user identity of the intelligent terminal device; and

receiving a response result information generated by the vehicle electronic key performing the setting operation through the intelligent terminal device, wherein the intelligent terminal device or the user using the intelligent terminal device determines the vehicle electronic key is in the location within the designated area range according to the response result information.

An embodiment of the present disclosure further provides apparatus used for determining a location of a vehicle electronic key, which includes:

a processor; and

a memory containing a program, when executed by the processor, the processor executes the following steps:

receiving a pending information transmitted by an intelligent terminal device through a vehicle electronic key located within a designated area range, wherein the designated area range is an area range in which the vehicle electronic key exists, the pending information comprises an authentication request information and an operation indicating information of an user identity of the intelligent terminal device, and the operation indicating information is used for indicating that an setting operation is performed after the vehicle electronic key authenticates the user identity of the intelligent terminal device;

performing an authentication process for the authentication request information of the user identity of the intelligent terminal device through the vehicle electronic key, and performing the setting operation according to the operation indicating information after the authentication; and

transmitting the response result information generated by the vehicle electronic key performing the setting operation to the intelligent terminal device through the vehicle electronic key, such that the intelligent terminal device or the user using the intelligent terminal device determines the vehicle electronic key is in the location within the designated area range according to the response result information generated by the vehicle electronic key performing the setting operation.

The embodiments of the present disclosure provide the method and the device for determining the vehicle electronic key, wherein the intelligent terminal device transmits the authentication request information of the user identity of the intelligent terminal device to the vehicle electronic key and the vehicle electronic key performs the operation of the ringing, the oscillating, or the combination of ringing and oscillating after the vehicle electronic key authenticates the user identity of the intelligent terminal device. Therefore, the vehicle electronic key authenticates the user identity of the intelligent terminal device, so as to ensure the user whose user identity is authenticated by the vehicle electronic key may find the vehicle electronic key. Thus the safety of searching the vehicle electronic key by the user is increased, thereby solving the problem that the safety of the method for searching the vehicle electronic key by using a searcher in the prior art is low.

### BRIEF DESCRIPTION OF THE DRAWING(S)

In order to illustrate the technical schemes of the prior art or the embodiments of the present disclosure more clearly, the accompanying drawings for illustrating the prior art or the embodiments of the present disclosure are briefly described as below. It is apparent that the drawings described below are merely some embodiments of the present disclosure, and those skilled in the art may derive other drawings according the drawings described below without creative endeavor. In the drawings:

FIG. 1 is a flowchart of a method for determining a location of a vehicle electronic key according to one embodiment of the present disclosure;

FIG. 2 is a flowchart of a method for determining a location of a vehicle electronic key according to one embodiment of the present disclosure;

FIG. 3 is a flowchart of a method for determining a location of a vehicle electronic key according to one embodiment of the present disclosure;

FIG. 4 is a schematic structure of a device for determining a location of a vehicle electronic key according to one embodiment of the present disclosure;

FIG. 5 is a schematic structure of a device for determining a location of a vehicle electronic key according to one embodiment of the present disclosure;

FIG. 6 is a schematic view of an apparatus used for determining a location of a vehicle electronic key according to one embodiment of the present disclosure; and

FIG. 7 is a schematic view of an apparatus used for determining a location of a vehicle electronic key according to one embodiment of the present disclosure.

### DESCRIPTION OF THE EMBODIMENTS

For the purpose, technical solution, and advantage of the present disclosure becoming clearer, the specific embodiments of the present disclosure combined with the accompanying drawings to clearly and completely are described as follows. Obviously, the described embodiments are only part of the embodiments of the present disclosure rather than all embodiments. Based on the embodiments of the present disclosure all other embodiments obtained by those having ordinary skills in this field without creative work are within the scope of protection of the present disclosure.

When the user buys the vehicle, the user may obtain the vehicle electronic key of the vehicle. In order to ensure the safety of the whole vehicle, the vehicle electronic key is uniquely matched with the vehicle, that is, one vehicle electronic key only has an operation authority for one vehicle, such as: opening or closing the door, turning on or turning off the engine. Each vehicle may perform the operations for opening or closing the door, turning on or turning off the engine by only using the vehicle electronic key which is uniquely matched with the vehicle.

After the user has lost or left out the vehicle electronic key, the user may not use the vehicle, thereby causing the great inconvenience for the user to travel. The embodiment of the present disclosure provides a method for determining a location of the vehicle electronic key; it is capable of helping the user to find the lost vehicle electronic key conveniently and quickly.

### Embodiment 1

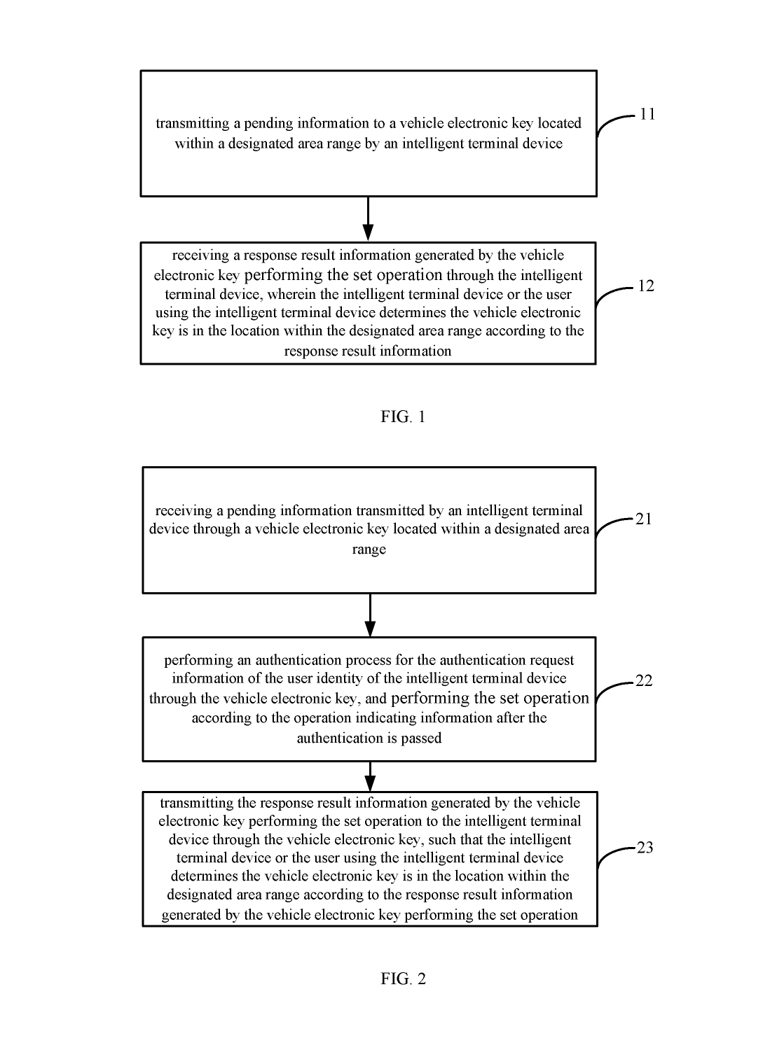

An embodiment of the present disclosure provides a device for determining a location of a vehicle electronic key. FIG. 1 is a flowchart of a method for determining a location of a vehicle electronic key according to one embodiment of the present disclosure. The method is as follows. An execution subject of the embodiment of the present disclosure is an intelligent terminal device.

Step 11: transmitting a pending information to a vehicle electronic key located within a designated area range by an intelligent terminal device.

Wherein, the designated area range is an area range which the vehicle electronic key exists, the pending information includes an authentication request information and an operation indicating information of an user identity of the intelligent terminal device, and the operation indicating information is used for indicating that an setting operation is performed after the vehicle electronic key authenticates the user identity of the intelligent terminal device.

In the step 11, the intelligent terminal device may be an intelligent phone; optionally, the intelligent terminal device may be other handheld device, and may also be a computer device, such as a notebook computer, a desktop computer, etc., and it is not specifically limited herein. The user uses the intelligent terminal device to transmit the pending information to the vehicle electronic key. In one embodiment, the user may transmit the pending information to the vehicle electronic key through a communication network, such as 2G network, 3G network, 4G network; optionally, the user may transmit the pending information to the vehicle electronic key through other network, such as a wireless network, for example, bluetooth, Wi-Fi, etc., and it is not specifically limited herein. If the user uses the communication network, the intelligent terminal device transmits the pending information to the vehicle electronic key in a short message manner; if the user uses other network, the intelligent terminal device transmits the pending information to the vehicle electronic key in a wireless message manner.

It should be noted that the present disclosure provides an application software, and the application software is used to assist the users to determine a location of the vehicle electronic key. The application software is installed on the intelligent terminal device. When the user needs to search the vehicle electronic key, the user uses the intelligent terminal device to transmit the pending information to the vehicle electronic key through the application software, the authentication information includes the intelligent terminal equipment pending request information and operating instructions, wherein the pending information includes an authentication request information and an operation indicating information of the intelligent terminal device. The authentication request information of the intelligent terminal device is used for requesting the vehicle electronic key to authenticates the user identity of the intelligent terminal device, so as to authenticate whether the user using the intelligent terminal device is legal, and the operation indicating information is used for indicating that an setting operation is performed after the vehicle electronic key authenticates the user identity of the intelligent terminal device.

When the user searches the vehicle electronic key, the user firstly determines an area range in which the vehicle electronic key may exist, that is an area range in which the vehicle electronic key is most likely to be lost. Here, the area range may be an area range of a place which the user has been visited at a most recent time, and may also be an area range which the user does daily activities. This is not specifically limited herein.

After the user determines area range in which the vehicle electronic key may exist, the user uses the intelligent terminal device to transmit the pending information to the vehicle electronic key located in the designated area range. Thus, when the vehicle electronic key receives the pending information transmitted by the intelligent terminal device, the vehicle electronic key performs a setting operation after the vehicle electronic key authenticates the user identity of the intelligent terminal device, such that the user may find the vehicle electronic key in the designated area range.

Step 12: receiving a response result information generated by the vehicle electronic key performing the setting operation through the intelligent terminal device, wherein the intelligent terminal device or the user using the intelligent terminal device determines the location within the designated area range for a the vehicle electronic key according to the response result information.

In the step 12, after the vehicle electronic key authenticates the user identity of the intelligent terminal device, the vehicle electronic key generates a response result information according the performed setting operation. For example, the vehicle electronic key performs a ringing operation according to the operation indicating information, and the intelligent terminal device receives an information of the performed ringing operation transmitted by the vehicle electronic key, such that the user using the intelligent terminal device determines a location of the ringing according to the performed ringing operation transmitted by the vehicle electronic key. Thus, the user may determine a specific location for the vehicle electronic key within the designated area range, thereby finding the vehicle electronic key.

It should be noted that the execution subject of the method for determining the vehicle electronic key provided by the embodiment of the present disclosure may the intelligent terminal device, and may also be the vehicle electronic key.

### Embodiment 2

FIG. 2 is a flowchart of a method for determining a location of a vehicle electronic key according to one embodiment of the present disclosure. The method is as follows. An execution subject of the embodiment of the present disclosure is a vehicle electronic key.

Step 21: receiving a pending information transmitted by an intelligent terminal device through a vehicle electronic key located within a designated area range.

Wherein the designated area range is an area range in which the vehicle electronic key may exist, the pending information includes an authentication request information and an operation indicating information of an user identity of the intelligent terminal device, and the operation indicating information is used for indicating that an setting operation is performed after the vehicle electronic key authenticates the user identity of the intelligent terminal device.

In the step 21, after the user determines the area range in which the lost vehicle electronic key may exist, the vehicle electronic key located within the designated area range received the pending information transmitted by an intelligent terminal device. The pending information includes an authentication request information and an operation indicating information of a user identity of the intelligent terminal device. After the vehicle electronic key receives the pending information of the user, the authentication request information and the operation indicating information included in the pending information is determined, such that the vehicle electronic key performs an authentication process for the authentication request information of the user identity of the intelligent terminal device.

Step 22: performing an authentication process for the authentication request information of the user identity of the intelligent terminal device through the vehicle electronic key, and performing the setting operation according to the operation indicating information after the authentication.

In the step 21, after the vehicle electronic key authenticates the authentication request information transmitted by the intelligent terminal device, the vehicle electronic key performs the setting operation according to the operation indicating information transmitted by the intelligent terminal device. Thus, the intelligent terminal device or the user using the intelligent terminal device may determines a specific location of the vehicle electronic key according to the setting operation performed by the vehicle electronic key, such that the user using the intelligent terminal device may fine the vehicle electronic key.

The specific operation of performing the authentication process for the authentication request information of the user identity of the intelligent terminal device through the vehicle electronic key includes as following.

Firstly, the vehicle electronic key determines an identification information of the user using the intelligent terminal device according to the received authentication request information of the user identity of the intelligent terminal device.

Then, the vehicle electronic key performs the authentication process for the authentication request information of the intelligent terminal device according to a predetermined corresponding relationship between an identification information of the vehicle electronic key and the identification information of the user using the intelligent terminal device.

The intelligent terminal device transmits the authentication request information to the vehicle electronic key, wherein the authentication request information includes the identification information of the user using the intelligent terminal device. The authentication request information is used for requesting the vehicle electronic key authenticates whether the user using the intelligent terminal device is a legal user according to the identification information of the user using the intelligent terminal device. The process of performing the authentication process for the authentication request information of the user identity of the intelligent terminal device through the vehicle electronic key is the process of determining whether the user using the intelligent terminal device is the legal user through the vehicle electronic key.

Specifically, the vehicle electronic key determines and obtains the identification information of the user using the intelligent terminal device, the vehicle electronic key determines the user using the intelligent terminal device is the legal user according to the predetermined corresponding relationship between the identification information of the vehicle electronic key and the identification information of the user using the intelligent terminal device.

It should be noted that the embodiment of the present disclosure may, but is not limited to, determine the predetermined corresponding relationship between an identification information of the vehicle electronic key and the identification information of the user using the intelligent terminal device by using the following manner.

The first step: the vehicle electronic key receives a request matching authority information transmitted by the intelligent terminal device, wherein the request matching authority information includes the identification information of the user using the intelligent terminal device and the identification information of the vehicle electronic key.

When the user buys the vehicle, the user may get a vehicle electronic key, which is the unique key matched with the vehicle. In order to ensure the uniqueness and the safety of the vehicle electronic key, the seller of the vehicle may copy the identification information of the user buying the vehicle to the interior of the vehicle electronic key. Here, the identification information of the user includes, but is not limited to, the identification number of the user and the phone number of the user using the intelligent phone. In addition, the seller of the vehicle may also copy the identification information of the vehicle electronic key to the interior of the vehicle electronic key. Here, the identification information of the vehicle electronic key includes, but is not limited to, the identifier of the vehicle electronic key and the identifier of the vehicle which is the unique identifier matched with the vehicle electronic key. The interior of the vehicle electronic key records the identification information of the user and the identification information of the vehicle electronic key, so as to process the request matching authority information transmitted by the user through the vehicle electronic key.

The request matching authority information includes the identification information of the user using the intelligent terminal device and the identification information of the vehicle electronic key. That is, the request matching authority information, transmitted to the vehicle electronic key through the intelligent terminal device, includes all the identification informations of the user and the vehicle electronic key. Here, all the identification information include, but are not limited to, the identification number of the user, the phone number of the user using the intelligent phone, the identifier of the vehicle electronic key and the identifier of the vehicle which is the unique identifier matched with the vehicle electronic key. The user only transmits all the identification information of the user and the vehicle electronic key to the vehicle electronic key, and then the vehicle electronic key authenticates all the identification information, and thus the user using the intelligent terminal device may obtain a matching authority matched with the vehicle electronic key.

The second step: if the identification information of the user using the intelligent terminal device and the identification information of the vehicle electronic key included in the request matching authority information received by the vehicle electronic key are consistent with an identification information of the user and an identification information of the vehicle electronic key pre-stored in the vehicle electronic key, the intelligent terminal device obtains a matching authority matched with the vehicle electronic key.

In the above first step, the vehicle electronic key already obtains the identification information of the user using the intelligent terminal device and the identification information of the user buying the vehicle which uniquely corresponds to the vehicle electronic key. If the identification information of the user using the intelligent terminal device is consistent with the identification information of the user buying the vehicle, the vehicle electronic key determines the user using the intelligent terminal device is the user buying the vehicle which uniquely corresponds to the vehicle electronic key, and thus the vehicle electronic key allows the intelligent terminal device to obtain the matching authority matched with the vehicle electronic key.

The third step: the vehicle electronic key determines the predetermined corresponding relationship between the identification information of the vehicle electronic key and the identification information of the user using the intelligent terminal device.

After the intelligent terminal device obtains the matching authority of the vehicle electronic key, the vehicle electronic key determines the predetermined corresponding relationship between the identification information of the vehicle electronic key and the identification information of the user using the intelligent terminal device, such that the vehicle electronic key is capable of conveniently and quickly authenticating the identification information of the user using the intelligent terminal device according to the predetermined corresponding relationship.

For authenticating the identification information of the user using the intelligent terminal device, specifically, when the intelligent terminal device transmits an information to the vehicle electronic key again, the intelligent terminal device does not need transmitting all the identification information of the intelligent terminal device and the user using the intelligent terminal device to the vehicle electronic key and only needs transmitting the identification information of the user using the intelligent terminal device to the vehicle electronic key, such that the vehicle electronic key only needs authenticating the identification information of the user using the intelligent terminal device to determine whether the identification information of the user using the intelligent terminal device is consistent with the identification information of the predetermined corresponding relationship. If the identification information of the user using the intelligent terminal device is consistent with the identification information of the predetermined corresponding relationship, the authentication passes; if the identification information of the user using the intelligent terminal device is not consistent with the identification information of the predetermined corresponding relationship, the authentication does not pass. Thus, the operation of the user using the intelligent terminal device is convenient, and the authentication process of the interior of the vehicle electronic key is also simplified.

When the identification information of the user using the intelligent terminal device is consistent with the identification information of the user included in the predetermined corresponding relationship, the vehicle electronic key authenticates the authentication request information of the user identity of the intelligent terminal device, so as to determines a legal state of the user using the intelligent terminal device. After the authentication, the vehicle electronic key performs the setting operation, such that the user may find the vehicle electronic key according to the setting operation performed by the vehicle electronic key.

It should be noted that the interior of the vehicle electronic key has a buzzer and an oscillator. When the vehicle electronic key needs performing a ringing operation according to the operation indicating information, the vehicle electronic key drives the buzzer and the buzzer then generates a voice; when the vehicle electronic key needs performing an oscillating operation according to the operation indicating information, the vehicle electronic key drives the oscillator and the oscillator then generates a oscillating; when the vehicle electronic key needs performing a ringing operation and an oscillating operation according to the operation indicating information, the vehicle electronic key simultaneously drives the buzzer and the oscillator, and the buzzer then generates a voice and the oscillator then generates a oscillating.

For the vehicle electronic key performs the setting operation according to the operation indicating information transmitted by the intelligent terminal device, specifically, the operation indicating information is used for indicating that performing a ringing operation after the vehicle electronic key authenticates the intelligent terminal device, wherein the vehicle electronic key triggers the buzzer, such that the buzzer performs the ringing operation;

or,

the operation indicating information is used for indicating that performing an oscillating operation after the vehicle electronic key authenticates the intelligent terminal device, wherein the vehicle electronic key triggers an oscillator, such that the oscillator performs the oscillating operation;

or,

the operation indicating information is used for indicating that performing a ringing operation and an oscillating operation after the vehicle electronic key authenticates the intelligent terminal device, wherein the vehicle electronic key simultaneously triggers a buzzer and an oscillator, such that the buzzer performs the ringing operation and the oscillator performs the oscillating operation.

The user selects a manner for searching the vehicle electronic key according to his/her habit, for example, if the user selects the manner for searching vehicle electronic key is the ringing, the operation indicating information is used for indicating that the vehicle electronic key performs the ringing operation, such that the user may determines the location of the vehicle electronic key according to the location of the ringing, thereby finding the vehicle electronic key; if the user selects the manner for searching vehicle electronic key is the oscillating, the operation indicating information is used for indicating that the vehicle electronic key performs the oscillating operation, such that the user may determines the location of the vehicle electronic key according to the location of the oscillating, thereby finding the vehicle electronic key; if the user selects the manner for searching vehicle electronic key is the ringing combined with the oscillating, the operation indicating information is used for indicating that the vehicle electronic key performs the ringing operation combined with oscillating operation, such that the user may determines the location of the vehicle electronic key according to the location of the ringing combined with the oscillating, thereby finding the vehicle electronic key.

In the step 23: transmitting the response result information generated by the vehicle electronic key performing the setting operation to the intelligent terminal device through the vehicle electronic key, such that the intelligent terminal device or the user using the intelligent terminal device determines the vehicle electronic key is in the location within the designated area range according to the response result information generated by the vehicle electronic key performing the setting operation.

After the vehicle electronic key performs the setting operation, the vehicle electronic key transmits the response result information to the intelligent terminal device, such that the user using the intelligent terminal device may promptly know whether the vehicle electronic key performs the setting operation.

After the intelligent terminal device receives the response result information generated by the vehicle electronic key, the intelligent terminal device may display whether the vehicle electronic key performs the setting operation, for example, the vehicle electronic key already performs the ringing operation. Thus a display interface of the intelligent terminal device may display an information indicating the vehicle electronic key already performs the ringing operation, such that the user may intuitively determines the vehicle electronic key performs the ringing operation. Therefore, the user may determine the location of the vehicle electronic key according to the location of the ringing, thereby finding the vehicle electronic key.

It should be noted that if the vehicle electronic key does not authenticate the user identity of the intelligent terminal device, the vehicle electronic key abandons the pending information transmitted by the intelligent terminal device and the vehicle electronic key does not perform the setting operation, and thus the vehicle electronic key may transmit the information indicating the vehicle electronic key authenticates the user identity of the intelligent terminal device is not passed to the intelligent terminal device, thereby prompting the identity authentication is not passed to the intelligent terminal device or the user using the intelligent terminal device.

By the aspect of the embodiment of the present disclosure, the intelligent terminal device transmits the pending information to the vehicle electronic key located within the designated area range, wherein the designated area range is an area range in which the vehicle electronic key may exist, the pending information includes an authentication request information and an operation indicating information of an user identity of the intelligent terminal device, and the operation indicating information is used for indicating that an setting operation is performed after the vehicle electronic key authenticates the user identity of the intelligent terminal device; the intelligent terminal device or the user using the intelligent terminal device determines the vehicle electronic key is in the location within the designated area range according to the response result information generated by the vehicle electronic key performing the setting operation. The user uses the intelligent terminal device to transmit the authentication request information of the user identity of the intelligent terminal device to the vehicle electronic key, and the vehicle electronic key performs the ringing operation, the oscillating operation or the ringing and oscillating operation after the user identity of the intelligent terminal device is authenticated to pass. Therefore, the vehicle electronic key authenticates the user identity of the intelligent terminal device, so as to ensure the user, which the user identity is authenticated by the vehicle electronic key, may find the vehicle electronic key. Thus the safety of searching the vehicle electronic key by the user is increased, thereby solving the problem that the safety of the method for searching the vehicle electronic key by using a searcher in the prior art is low.

The execution subject of the method for determining the vehicle electronic key provided by the embodiment of the present disclosure may the intelligent terminal device, and may also be the vehicle electronic key. The two executive bodies are combined to achieve the specific implementation steps of the method for determining the location of the vehicle electronic key of the embodiment of the present disclosure.

### Embodiment 3

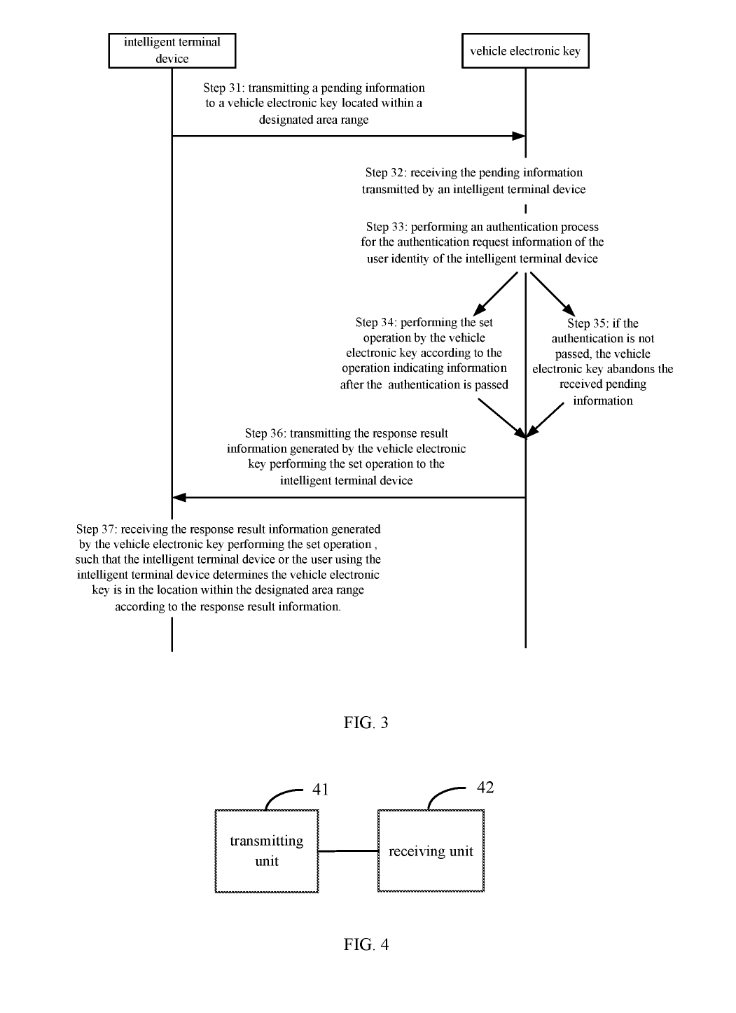

FIG. 3 is a flowchart of a method for determining a location of a vehicle electronic key according to one embodiment of the present disclosure. The method is as follows.

Step 31: transmitting a pending information to a vehicle electronic key located within a designated area range by an intelligent terminal device.

Wherein, the designated area range is an area range which the vehicle electronic key may exist, the pending information includes an authentication request information and an operation indicating information of an user identity of the intelligent terminal device, the operation indicating information is used for indicating that an setting operation is performed after the vehicle electronic key authenticates the user identity of the intelligent terminal device.

Step 32: receiving the pending information transmitted by an intelligent terminal device through the vehicle electronic key located within the designated area range.

Wherein, the designated area range is an area range in which the vehicle electronic key may exist, the pending information includes an authentication request information and an operation indicating information of an user identity of the intelligent terminal device, and the operation indicating information is used for indicating that an setting operation is performed after the vehicle electronic key authenticates the user identity of the intelligent terminal device.

Step 33: performing an authentication process for the authentication request information of the user identity of the intelligent terminal device through the vehicle electronic key.

In the step 33, the vehicle electronic key determines whether the identification information of the user using the intelligent terminal device included in the authentication request information exists a predetermined corresponding relationship with the vehicle electronic key; if yes, goes to step 34, and if not, goes to step 35.

Step 34: performing the setting operation by the vehicle electronic key according to the operation indicating information after the vehicle electronic key authenticates the authentication request information of the user identity of the intelligent terminal device.

In the step 34, the operation indicating information is used for indicating that performing a ringing operation after the vehicle electronic key authenticates the user identity of the intelligent terminal device, wherein the vehicle electronic key triggers a buzzer, such that the buzzer performs the ringing operation;

the operation indicating information is used for indicating that performing an oscillating operation after the vehicle electronic key authenticates the intelligent terminal device, wherein the vehicle electronic key triggers an oscillator, such that the oscillator performs the oscillating operation;

the operation indicating information is used for indicating that performing a ringing operation and an oscillating operation after the vehicle electronic key authenticates the intelligent terminal device, wherein the vehicle electronic key simultaneously triggers a buzzer and an oscillator, such that the buzzer performs the ringing operation and the oscillator performs the oscillating operation.

Step 35: if the vehicle electronic key does not authenticate the authentication request information of the user identity of the intelligent terminal device, the vehicle electronic key abandons the received pending information.

Step 36: transmitting the response result information generated by the vehicle electronic key performing the setting operation to the intelligent terminal device through the vehicle electronic key.

In the step 36, if the vehicle electronic key authenticates the authentication request information of the user identity of the intelligent terminal device, the vehicle electronic key transmits the information which the vehicle electronic key performs the setting operation to the intelligent terminal device; if the vehicle electronic key does not authenticate the authentication request information of the user identity of the intelligent terminal device, the vehicle electronic key transmits the information indicating the authentication is not passed to the intelligent terminal device.

Step 37: receiving the response result information generated by the vehicle electronic key performing the setting operation through the intelligent terminal device, such that the intelligent terminal device or the user using the intelligent terminal device determines the vehicle electronic key is in the location within the designated area range according to the response result information.

In the step 37, the user using the intelligent terminal device may determines the vehicle electronic key already performs the setting operation according to the response result information transmitted by the vehicle electronic key, such that the user using the intelligent terminal device may conveniently and quickly find the vehicle electronic key according to the operation performed by the vehicle electronic key.

In the method for determining the location of the vehicle electronic key provided by the embodiment of the present disclosure, the specific procedure for searching the vehicle electronic key by using the intelligent phone is illustrated by the case of the intelligent phone as follows:

first step: the application software is installed on the intelligent phone by the user, and the application software may help the user to searching the vehicle electronic key;

second step: the user inputs a personal information which is registered when the user buys the vehicle on the installed application software, the personal information includes the phone number and the identification number of the user. In addition, the user further inputs an identifier which needs searching the vehicle electronic key and an identifier of the vehicle which uniquely corresponds the vehicle electronic key, and the user transmits these information served as a request matching authority information to the vehicle electronic key.

The intelligent phone transmits the request matching authority information to the vehicle electronic key based on the communication network, wherein the transmitting information manner may be the short message manner, and may be other communication manner, and it is not limited here. The interior of the vehicle electronic key is equipped with a signal receiving module of the communication network. Thus the vehicle electronic key receives the request matching authority information transmitted by the intelligent phone through the signal receiving module.

Third step: the vehicle electronic key determines the identification information of the user and the identification information of the vehicle electronic key included in the request matching authority information according to the request matching authority information, and the vehicle electronic key matches these information with the identification information of the user and the identification information of the vehicle electronic key stored in the interior of the vehicle electronic key; and if these information is consistent with the identification information of the user and the identification information of the vehicle electronic key stored in the interior of the vehicle electronic key. Thus the intelligent terminal device used by the user obtains the matching authority of the vehicle electronic key.

Fourth step: when the user searches the vehicle electronic key, the user firstly determines the area range which the vehicle electronic key may exist, and then uses the intelligent phone to transmit the pending information to the vehicle electronic key located within the designated area range, wherein the pending information includes the phone number of the user using the intelligent phone and the manner for searching the vehicle electronic key selected by the user. Thus the vehicle electronic key only need determining whether the phone number of the user using the intelligent phone is a phone number which has been matched before; if yes, the vehicle electronic key the setting operation according to the manner for searching the vehicle electronic key selected by the user, such as: the ringing operation, the oscillating operation, or the ringing operation combined with the oscillating operation.

Fifth step: after the vehicle electronic key performs the ringing operation, the oscillating operation, or the ringing operation combined with the oscillating operation, the vehicle electronic key transmits the result information of the performed operation to the intelligent phone used by the user. Thus the user may conveniently and quickly find the vehicle electronic key.

It should be noted that the existing keyless start system (passive entry and passive start, PEPS) technique may also help the user to determine the location of the vehicle electronic key, wherein the determining method is: when the vehicle electronic key is left inside the vehicle, the user may not achieve the closing operation of the vehicle door. Thus the function of PEPS may alert that the vehicle electronic key is left inside the vehicle to the user. However, it may only determine some approximate area which the vehicle electronic key exists, but it may not intuitively and conveniently determine the specific location of the vehicle electronic key, and during the period that the user does not drive the vehicle, the function of PEPS may not help the user to determine the approximate area of the vehicle electronic key. The embodiment of the present disclosure provides the method for determining the location of the vehicle electronic key, such that the user may find the vehicle electronic key regardless of the period during which the user drives the vehicle or the user does not drive the vehicle.

It should be noted that, in real life, one user may have different vehicle electronic keys. Thus the users may find each vehicle electronic key by using the method provided by the embodiment of the present disclosure. Each vehicle electronic key has unique identifier. Thus the user needs determining the predetermined corresponding relationship between the identification information of the vehicle electronic key and the identification information of the user for each vehicle electronic key. When the user needs searching one of the vehicle electronic keys, the user may select the vehicle electronic key which needs searching in the application software installed on the intelligent terminal device and then transmits the pending information to the vehicle electronic key which needs searching. Therefore, the embodiment of the present disclosure provides the method for determining the location of the vehicle electronic key, such that may conveniently and quickly find the vehicle electronic key.

It should be noted that the user may set other phone number with an authority used for searching the vehicle electronic key by setting the vehicle electronic key. For example, the user A wishes to use the phone number of his/her family B for searching the vehicle electronic key, the user needs transmitting the phone number of B to the vehicle electronic key, such that the vehicle electronic key determines the predetermined corresponding relationship between the identification information of B and the identification information of the vehicle electronic key. Thus the phone number of B is capable of searching the vehicle electronic key. However, this authority may only be set by the user A, that is, even if the user B may use the intelligent phone to find the vehicle electronic key, but the user B may not set the other user which has the authority for searching the vehicle electronic key.

The embodiment of the present disclosure provides the method for determining the location of the vehicle electronic key, wherein the intelligent terminal device transmits the request matching authority information to the vehicle electronic key, and the vehicle electronic key authenticates the user identity of the intelligent terminal device. After the vehicle electronic key only authenticates the intelligent terminal device, the intelligent terminal device may obtain the matching authority of the vehicle electronic key. After the intelligent terminal device obtains the matching authority, the vehicle electronic key determines the predetermined corresponding relationship between the identification information of the vehicle electronic key and the identification information of the user using the intelligent terminal device. That is, for the vehicle electronic key, after the pending information transmitted by the user using the intelligent terminal device which has the predetermined corresponding relationship with the vehicle electronic key is received, the vehicle electronic key may perform the setting operation. With respect to the transmitter and the searcher in the prior technique, the safety of the technique provided by the embodiment of the present disclosure is high.

### Embodiment 4

FIG. 4 is a schematic structure of a device for determining a location of a vehicle electronic key according to one embodiment of the present disclosure. The device includes: a transmitting unit 41 and a receiving unit 42, wherein:

a transmitting unit 41 is used for transmitting a pending information to a vehicle electronic key located within a designated area range, wherein the designated area range is an area range in which the vehicle electronic key may exist, the pending information includes an authentication request information and an operation indicating information of an user identity of the intelligent terminal device, and the operation indicating information is used for indicating that an setting operation is performed after the vehicle electronic key authenticates the user identity of the intelligent terminal device; and

a receiving unit 42 is used for receiving a response result information generated by the vehicle electronic key performing the setting operation, wherein the intelligent terminal device or the user using the intelligent terminal device determines the vehicle electronic key is in the location within the designated area range according to the response result information.

The transmitting unit 41 transmits the pending information to the vehicle electronic key. After the vehicle electronic key processes the pending information, the vehicle electronic feedbacks a response result information to the transmitting unit, and then the receiving unit 42 receives the response result information of the vehicle electronic key. Thus, the user may conveniently and quickly find the vehicle electronic key according to the response result information of the vehicle electronic key received by the receiving unit 42.

### Embodiment 5

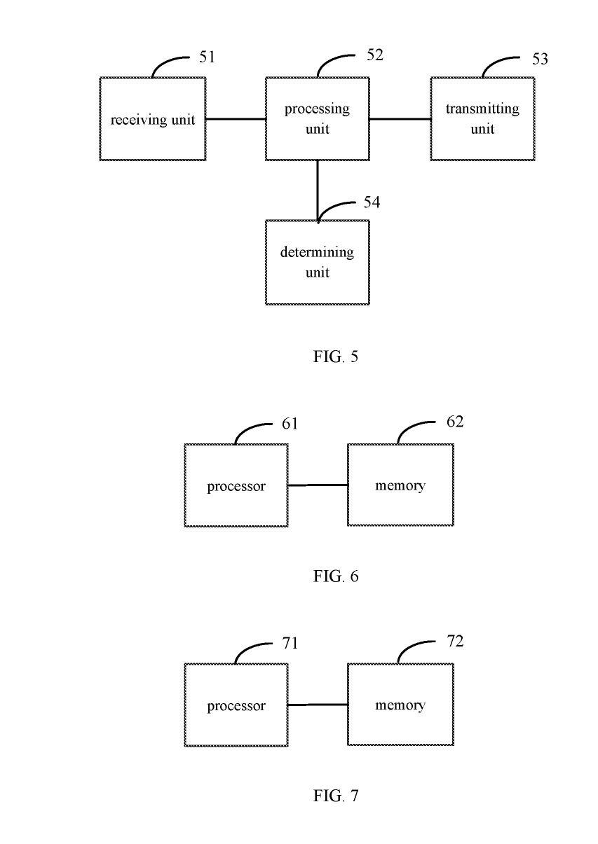

FIG. 5 is a schematic structure of a device for determining a location of a vehicle electronic key according to one embodiment of the present disclosure. The device includes: a receiving unit 51, a processing unit 52 and a transmitting unit 53, wherein:

a receiving unit 51 is used for receiving a pending information transmitted by an intelligent terminal device, wherein the pending information includes an authentication request information and an operation indicating information of an user identity of the intelligent terminal device, and the operation indicating information is used for indicating that an setting operation is performed after the vehicle electronic key authenticates the user identity of the intelligent terminal device;

a processing unit 52 is used for performing an authentication process for the authentication request information of the user identity of the intelligent terminal device, and performing the setting operation according to the operation indicating information after the authentication is passed; and

a transmitting unit 53 is used for transmitting the response result information generated by the vehicle electronic key performing the setting operation to the intelligent terminal device, such that the intelligent terminal device or the user using the intelligent terminal device determines the vehicle electronic key is in the location within the designated area range according to the response result information generated by the vehicle electronic key performing the setting operation.

The processing unit 52 used for performing the authentication process for the authentication request information of the user identity of the intelligent terminal device through the vehicle electronic key includes the following steps:

determining an identification information of the user using the intelligent terminal device according to the authentication request information of the user identity of the intelligent terminal device is received; and

performing the authentication process for the authentication request information of the user identity of the intelligent terminal device according to a predetermined corresponding relationship between an identification information of the vehicle electronic key and the identification information of the user using the intelligent terminal device.

The device for determining the location of the vehicle electronic key provided by the embodiment of the present disclosure further includes: a determining unit 54, wherein:

the determining unit 54 is used for determining the predetermined corresponding relationship between the identification information of the vehicle electronic key and the identification information of the user using the intelligent terminal device, which includes the following steps:

receiving a request matching authority information transmitted by the intelligent terminal device, wherein the request matching authority information includes the identification information of the user using the intelligent terminal device and the identification information of the vehicle electronic key;

if the identification information of the user using the intelligent terminal device and the identification information of the vehicle electronic key included in the received request matching authority information are consistent with an identification information of the user and an identification information of the vehicle electronic key pre-stored in the vehicle electronic key, the intelligent terminal device obtains a matching authority matched with the vehicle electronic key; and

determining the predetermined corresponding relationship between the identification information of the vehicle electronic key and the identification information of the user using the intelligent terminal device.

The processing unit 52 used performing the setting operation according to the operation indicating information after authenticating the user identity of the intelligent terminal device includes the following steps:

when the identification information of the user using the intelligent terminal device is consistent with an identification information of the user included in the predetermined corresponding relationship, the vehicle electronic key authenticates the authentication request information of the user identity of the intelligent terminal device;

The processing unit 52 performing the setting operation according to the operation indicating information after the authentication includes the following steps:

the operation indicating information is used for indicating that performing a ringing operation after the vehicle electronic key authenticates the intelligent terminal device, wherein the vehicle electronic key triggers a buzzer, such that the buzzer performs the ringing operation;

or,

the operation indicating information is used for indicating that performing an oscillating operation after the vehicle electronic key authenticates the intelligent terminal device, wherein the vehicle electronic key triggers an oscillator, such that the oscillator performs the oscillating operation;

or,

the operation indicating information is used for indicating that performing an ringing operation and an oscillating operation after the vehicle electronic key authenticates the intelligent terminal device, wherein the vehicle electronic key simultaneously triggers a buzzer and an oscillator, such that the buzzer performs the ringing operation and the oscillator performs the oscillating operation.

FIG. 6 is a schematic view of an apparatus used for determining a location of a vehicle electronic key according to one embodiment of the present disclosure. The apparatus used for determining the location of the vehicle electronic key includes:

a processor 61; and

a memory 62 containing a program, when executed by the processor, the processor executes the following steps:

transmitting a pending information to a vehicle electronic key located within a designated area range by an intelligent terminal device, wherein the designated area range is an area range in which the vehicle electronic key exists, the pending information comprises an authentication request information and an operation indicating information of an user identity of the intelligent terminal device, and the operation indicating information is used for indicating that an setting operation is performed after the vehicle electronic key authenticates the user identity of the intelligent terminal device; and

receiving a response result information generated by the vehicle electronic key performing the setting operation through the intelligent terminal device, wherein the intelligent terminal device or the user using the intelligent terminal device determines the vehicle electronic key is in the location within the designated area range according to the response result information.

FIG. 7 is a schematic view of an apparatus used for determining a location of a vehicle electronic key according to one embodiment of the present disclosure. The apparatus used for determining the location of the vehicle electronic key includes:

a processor 71; and

a memory 72 containing a program, when executed by the processor, the processor executes the following steps:

receiving a pending information transmitted by an intelligent terminal device through a vehicle electronic key located within a designated area range, wherein the designated area range is an area range in which the vehicle electronic key exists, the pending information comprises an authentication request information and an operation indicating information of an user identity of the intelligent terminal device, and the operation indicating information is used for indicating that an setting operation is performed after the vehicle electronic key authenticates the user identity of the intelligent terminal device;

performing an authentication process for the authentication request information of the user identity of the intelligent terminal device through the vehicle electronic key, and performing the setting operation according to the operation indicating information after the authentication; and

transmitting the response result information generated by the vehicle electronic key performing the setting operation to the intelligent terminal device through the vehicle electronic key, such that the intelligent terminal device or the user using the intelligent terminal device determines the vehicle electronic key is in the location within the designated area range according to the response result information generated by the vehicle electronic key performing the setting operation.

It should be noted that the device for determining the location of the vehicle electronic key of the embodiment of the present disclosure may be implemented by a hardware manner and may also be implemented by a software manner, and thus it is not limited here.

The apparatus embodiments described above are merely illustrative, wherein the unit described as a separate member may or may not be physically separate, and the components shown as a unit may or may not be physical units, i.e., it may be located in one place, or may be distributed to various network elements. Some or all of the modules may be selected to achieve the purpose of the present examples of the embodiments according to the actual need. Those of ordinary skill in the case may understand and implement the present disclosure without paying any creative work.

The above description of embodiments, those skilled in the art can clearly understand the various embodiments may be implemented by software plus a necessary universal hardware platform for implementation, and of course, also be implemented by hardware. Based on this understanding, the nature of the technical proposal or the part contributing to the prior art may be embodied in the form of a software product. The computer software product may be stored in a computer readable storage medium, such as ROM/RAM, magnetic disc, CD-ROM, including several instructions to instruct a computer device (a personal computer, a server, or a network equipment) to perform the method described in some parts of the various embodiments or examples.

Finally, it should be noted that the above embodiments are merely provided for describing the technical solutions of the present disclosure, but not intended to limit the present disclosure. Although reference to the embodiments of the present disclosure has been described in details, those skilled in the art will appreciate that the technical solutions described in the foregoing embodiments can be modified, or equivalently replaced for some technical features; and such modifications or replacements do not make the essence of the corresponding technical solutions depart from the spirit and scope of the technical implementation of the present disclosure.

What is claimed is:

1. A method for determining a location of a vehicle electronic key, comprising:
transmitting a pending information to a vehicle electronic key located within a designated area range by an intelligent terminal device, wherein the designated area range is an area range in which the vehicle electronic key exists, the pending information comprises an authentication request information and an operation indicating information of an user identity of the intelligent terminal device, and the operation indicating information is used for indicating that an setting operation is performed after the vehicle electronic key authenticates the user identity of the intelligent terminal device; and
receiving a response result information generated by the vehicle electronic key performing the setting operation through the intelligent terminal device, wherein the intelligent terminal device or the user using the intelligent terminal device determines the vehicle electronic key is in the location within the designated area range according to the response result information.

2. A method for determining a location of a vehicle electronic key, comprising:
receiving a pending information transmitted by an intelligent terminal device through a vehicle electronic key located within a designated area range, wherein the designated area range is an area range in which the vehicle electronic key exists, the pending information comprises an authentication request information and an operation indicating information of an user identity of the intelligent terminal device, and the operation indicating information is used for indicating that an setting operation is performed after the vehicle electronic key authenticates the user identity of the intelligent terminal device;
performing an authentication process for the authentication request information of the user identity of the intelligent terminal device through the vehicle electronic key, and performing the setting operation according to the operation indicating information after the authentication; and
transmitting the response result information generated by the vehicle electronic key performing the setting operation to the intelligent terminal device through the vehicle electronic key, such that the intelligent terminal device or the user using the intelligent terminal device determines the vehicle electronic key is in the location within the designated area range according to the response result information generated by the vehicle electronic key performing the setting operation.

3. The method for determining the location of the vehicle electronic key according to claim 2, wherein the step of performing the authentication process for the authentication request information of the user identity of the intelligent terminal device through the vehicle electronic key comprises:
determining an identification information of the user using the intelligent terminal device through the vehicle electronic key according to the authentication request information of the user identity of the intelligent terminal device is received; and
performing the authentication process for the authentication request information of the user identity of the intelligent terminal device through the vehicle electronic key according to a predetermined corresponding relationship between an identification information of the vehicle electronic key and the identification information of the user using the intelligent terminal device.

4. The method for determining the location of the vehicle electronic key according to claim 3, wherein the predetermined corresponding relationship between an identification information of the vehicle electronic key and the identification information of the user using the intelligent terminal device is determined by using the following manner, comprising:
receiving a request matching authority information transmitted by the intelligent terminal device through the vehicle electronic key, wherein the request matching authority information comprises the identification information of the user using the intelligent terminal device and the identification information of the vehicle electronic key;
if the identification information of the user using the intelligent terminal device and the identification information of the vehicle electronic key included in the request matching authority information received by the vehicle electronic key are consistent with an identification information of the user and an identification information of the vehicle electronic key pre-stored in the vehicle electronic key, the intelligent terminal device obtains a matching authority matched with the vehicle electronic key; and
determining the predetermined corresponding relationship between the identification information of the vehicle electronic key and the identification information of the user using the intelligent terminal device through the vehicle electronic key.

5. The method for determining the location of the vehicle electronic key according to claim 2, wherein the step of performing the setting operation according to the operation indicating information after the authentication comprises:
when the identification information of the user using the intelligent terminal device is consistent with an identification information of the user included in the predetermined corresponding relationship, the vehicle electronic key authenticates the authentication request information of the user identity of the intelligent terminal device;
the step of performing the setting operation according to the operation indicating information after the authentication comprises:
the operation indicating information is used for indicating that performing a ringing operation after the vehicle electronic key authenticates the intelligent terminal device, wherein the vehicle electronic key triggers a buzzer, such that the buzzer performs the ringing operation;
or,
the operation indicating information is used for indicating that performing an oscillating operation after the vehicle electronic key authenticates the intelligent terminal device, wherein the vehicle electronic key triggers an oscillator, such that the oscillator performs the oscillating operation;
or,
the operation indicating information is used for indicating that performing a ringing operation and an oscillating operation after the vehicle electronic key authenticates the intelligent terminal device, wherein the vehicle electronic key simultaneously triggers a buzzer and an oscillator, such that the buzzer performs the ringing operation and the oscillator performs the oscillating operation.

6. An apparatus, used for determining a location of a vehicle electronic key, the apparatus comprising:
a processor; and
a memory containing a program, when executed by the processor, the processor executes the following steps:
transmitting a pending information to a vehicle electronic key located within a designated area range by an intelligent terminal device, wherein the designated area range is an area range in which the vehicle electronic key exists, the pending information comprises an authentication request information and an operation indicating information of an user identity of the intelligent terminal device, and the operation indicating information is used for indicating that an setting operation is performed after the vehicle electronic key authenticates the user identity of the intelligent terminal device; and
receiving a response result information generated by the vehicle electronic key performing the setting operation through the intelligent terminal device, wherein the intelligent terminal device or the user using the intelligent terminal device determines the vehicle electronic key is in the location within the designated area range according to the response result information.

7. An apparatus, used for determining a location of a vehicle electronic key, the apparatus comprising:
a processor; and
a memory containing a program, when executed by the processor, the processor executes the following steps:
receiving a pending information transmitted by an intelligent terminal device through a vehicle electronic key located within a designated area range, wherein the designated area range is an area range in which the vehicle electronic key exists, the pending information comprises an authentication request information and an operation indicating information of an user identity of the intelligent terminal device, and the operation indicating information is used for indicating that an setting operation is performed after the vehicle electronic key authenticates the user identity of the intelligent terminal device;
performing an authentication process for the authentication request information of the user identity of the intelligent terminal device through the vehicle electronic key, and performing the setting operation according to the operation indicating information after the authentication; and
transmitting the response result information generated by the vehicle electronic key performing the setting operation to the intelligent terminal device through the vehicle electronic key, such that the intelligent terminal device or the user using the intelligent terminal device determines the vehicle electronic key is in the location within the designated area range according to the response result information generated by the vehicle electronic key performing the setting operation.

8. The apparatus according to claim 7, wherein the processing unit used for performing the authentication process for the authentication request information of the user identity of the intelligent terminal device comprises the following steps:
determining an identification information of the user using the intelligent terminal device according to the authentication request information of the user identity of the intelligent terminal device is received; and
performing the authentication process for the authentication request information of the user identity of the intelligent terminal device according to a predetermined corresponding relationship between an identification information of the vehicle electronic key and the identification information of the user using the intelligent terminal device.

9. The apparatus according to claim 8, further comprising: a determining unit, wherein
the determining unit, for determining the predetermined corresponding relationship between the identification information of the vehicle electronic key and the identification information of the user using the intelligent terminal device, which comprises the following steps:
receiving a request matching authority information transmitted by the intelligent terminal device, wherein the request matching authority information comprises the identification information of the user using the intelligent terminal device and the identification information of the vehicle electronic key;
if the identification information of the user using the intelligent terminal device and the identification information of the vehicle electronic key included in the received request matching authority information are consistent with an identification information of the user and an identification information of the vehicle electronic key pre-stored in the vehicle electronic key, the intelligent terminal device obtains a matching authority matched with the vehicle electronic key; and
determining the predetermined corresponding relationship between the identification information of the vehicle electronic key and the identification information of the user using the intelligent terminal device.

10. The apparatus according to claim 7, wherein the processing unit used performing the setting operation according to the operation indicating information after the authentication comprises the following steps:
when the identification information of the user using the intelligent terminal device is consistent with an identification information of the user included in the predetermined corresponding relationship, the vehicle electronic key authenticates the authentication request information of the user identity of the intelligent terminal device;
the processing unit performing the setting operation according to the operation indicating information after the authentication comprises the following steps:
the operation indicating information is used for indicating that performing a ringing operation after the vehicle electronic key authenticates the intelligent terminal device, wherein the vehicle electronic key triggers a buzzer, such that the buzzer performs the ringing operation;
or,
the operation indicating information is used for indicating that performing an oscillating operation after the vehicle electronic key authenticates the intelligent terminal device, wherein the vehicle electronic key triggers an oscillator, such that the oscillator performs the oscillating operation;
or,
the operation indicating information is used for indicating that performing an ringing operation and an oscillating operation after the vehicle electronic key authenticates the intelligent terminal device, wherein the vehicle electronic key simultaneously triggers a buzzer and an oscillator, such that the buzzer performs the ringing operation and the oscillator performs the oscillating operation.
